(19) United States
(12) Patent Application Publication
(10) Pub. No.: US 2009/0194404 A1
(43) Pub. Date: Aug. 6, 2009

(54) PRESSING-TYPE INPUT DEVICE

(76) Inventors: Yoshizo Kubo, Fukushima-ken (JP); Shinji Hirano, Fukushima-ken (JP); Hideki Ito, Fukushima-ken (JP); Masaru Komatsu, Fukushima-ken (JP); Tadamitsu Sato, Fukushima-ken (JP)

Correspondence Address: BRINKS HOFER GILSON & LIONE, P.O. BOX 10395, CHICAGO, IL, 60610, US

(21) Appl. No.: 12/360,374

(22) Filed: Jan. 27, 2009

(30) Foreign Application Priority Data
Jan. 31, 2008 (JP) 2008-021607

(51) Int. Cl. H01H 13/76

(52) U.S. Cl. 200/5 D

(57) ABSTRACT

A pressing-type input device includes an operation part and pressure sensors that are provided on the lower surface of the operation part. The operation part includes an operation region where the pressure sensors are provided, and an outer region that is formed outside the operation region. An inner portion of the operation region is locally more flexible than the outer region that is formed outside the operation region.

### RELATED APPLICATION

The present invention claim priority to Japanese Patent Application No. 2008-021607 filed in the Japanese Patent Office on Jan. 31, 2008, the entire contents of which being incorporated herein by reference.

### BACKGROUND

1. Technical Field

The present disclosure relates to a pressing-type input device that is used in a mobile terminal and the like, and more particularly, to a pressing-type input device that can detect a pressing force and a pressing position.

2. Related Art

For example, in the following Japanese Unexamined Patent Application Publication No. 2005-352927 there is proposed an input device that generates a detection signal according to a pressing force.

Two kinds of input devices, that is, a press resistance change type input device and a capacitance type input device are disclosed in this Japanese Unexamined Patent Application Publication No. 2005-352927.

The press resistance change type input device is a device where electrical resistance is changed by a pressing force, and is formed by forming silver layers where sensors form conductive wiring on both surfaces of a carbon ink layer and laminating a PET layer for protecting the silver layers thereon. If pressure is applied to the PET layer from the outside by a finger, a distance between upper and lower silver layers is decreased and a resistance value between the silver layers is decreased. Accordingly, when a voltage is applied between the silver layers, the press resistance change type input device detects a pressing force from the change of a voltage value.

The capacitance type input device includes a sensor where two electrodes X and Y are disposed to face each other. If a pressing force applied to an operation surface becomes strong, a contact area is increased and an electric line of force formed between the electrodes X and Y is partially absorbed, so that the capacitance therebetween is decreased. The capacitance type input device detects a pressing force from the change of the capacitance.

A sensor having the shape of a thin sheet has been fixed to the outer surface in the input devices that are disclosed in Japanese Unexamined Patent Application Publication No. 2005-352927. However, since the surface of the sensor can be seen from the outside, the design may deteriorate.

In this case, the sensor is fixed to the inner surface (or lower surface) of the case in order to improve the design.

However, it is difficult to ensure the operability and comfort of the sensor only by fixing the sensor, which is to be fixed to the outer surface of the case, to the inner surface of the case.

That is, if the surface thickness of the case is excessively large, the surface of the case is hardly deformed even though being pressed. For this reason, a pressing force is not transmitted and the sensitivity of the sensor is apt to decrease.

Meanwhile, if the surface thickness of the case is excessively small, the surface of the case is extremely deformed when being pressed. For this reason, since a portion, which does not need to be bent, is also deformed, it is not possible to perform an appropriate input operation.

Further, the input devices, which are disclosed in Japanese Unexamined Patent Application Publication No. 2005-352927, determine a pressing force on the basis of the detection result of the sensor, but cannot specify a position (pressing position) on the surface of the case to which a pressing force is applied.

As for a tablet device that includes two resistive element films disposed to face each other, it is possible to calculate a pressing position by detecting the change of the resistive element. However, as for a small tablet device, a detection error is large and it is difficult to accurately detect a pressing position or a pressing force.

### SUMMARY

A pressing-type input device includes an operation part and pressure sensors that are provided on the lower surface of the operation part. The operation part includes an operation region where the pressure sensors are provided, and an outer region that is formed outside the operation region. An inner portion of the operation region is locally more flexible than the outer region that is formed outside the operation region.

According to this aspect, it is possible to definitely divide the flexible operation region from the outer region that has high rigidity with no deformation. Accordingly, even though the outer region having high rigidity is pressed by mistake, the pressure sensor may not detect this input operation. For this reason, it is possible to press an operator for an appropriate pressing operation.

### BRIEF DESCRIPTION OF THE DRAWINGS

FIG. 1 is a plan view showing the appearance of a mobile phone that includes a pressing-type input device according to an embodiment of the invention.

FIG. 2 is a perspective view showing the back surface of the pressing-type input device according to the embodiment of the invention.

FIG. 3 is a cross-sectional view of FIG. 2.

FIG. 4 shows another embodiment of an operation part, FIG. 4A is a perspective view showing the back surface of the operation part that includes an annular rib having double structure, and FIG. 4B is a perspective view showing the back surface of the operation part that includes reinforcing ribs.

FIG. 5 is a graph showing a relationship between the diameter of the annular rib and the thickness of an operation region.

FIG. 6 shows the disposition of pressure sensors of the pressing-type input device, FIG. 6A is a cross-sectional view of the pressing-type input device when the pressing-type input device is deformed, and FIG. 6B is a plan view schematically showing the back surface of the pressing-type input device.

FIG. 7 is a graph showing an example of a relationship between a pressing force and the resistance change of a pressure sensor at an arbitrary pressing position S, FIG. 7A is a view showing a case where the pressing position is positioned on a positive side on an X axis, and FIG. 7B is a view showing a case where the pressing position is positioned on a negative side on an X axis.

FIG. 8 is a graph showing a relationship between a pressing position and a variation.

FIG. 9 is a conceptual diagram illustrating a method of finding the coordinates of the pressing position by using a coordinate detection table.

### DESCRIPTION OF EXEMPLARY EMBODIMENTS

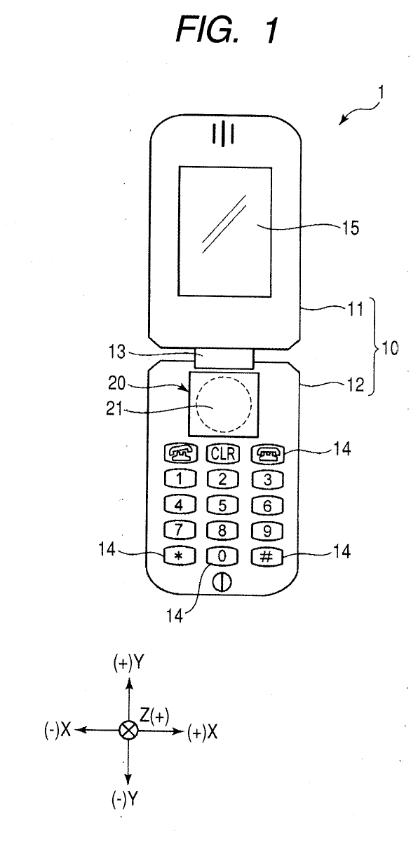

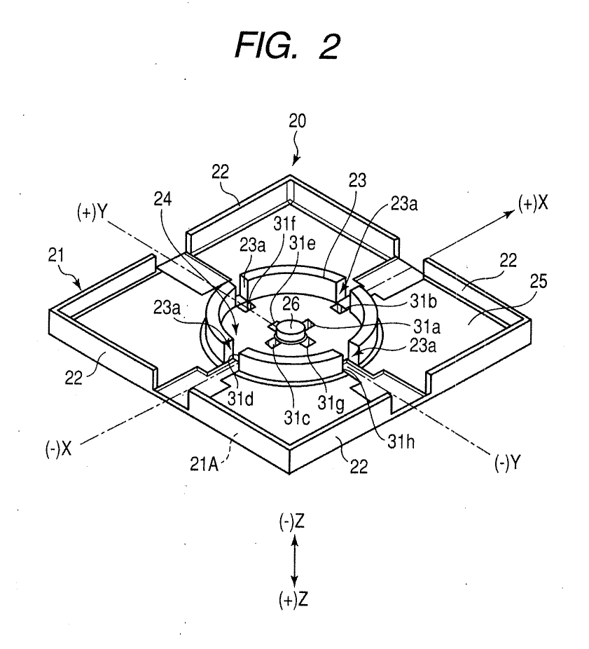

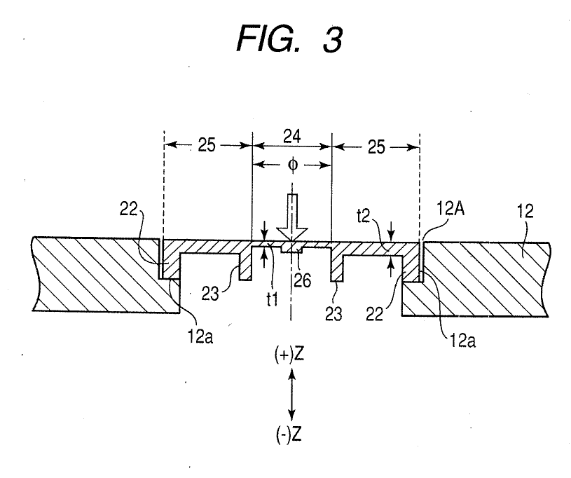

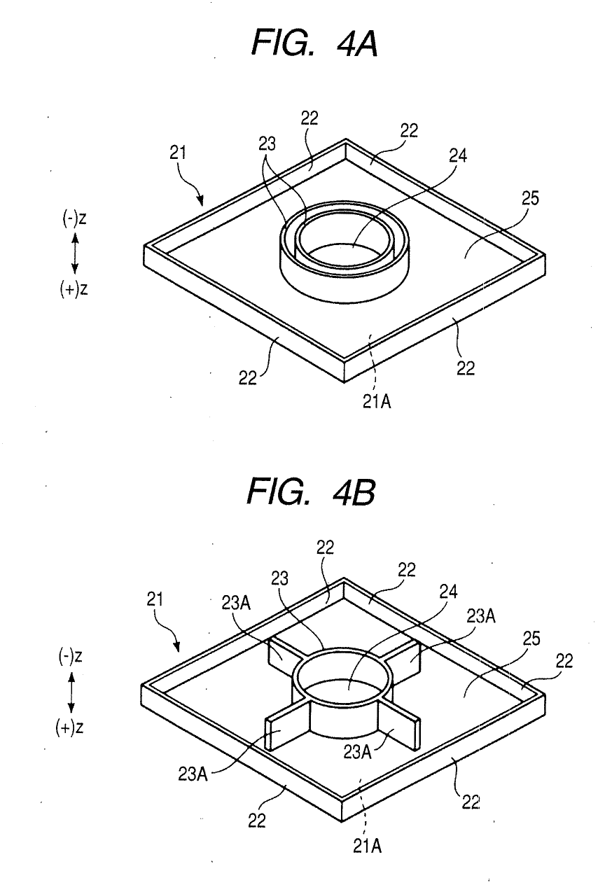

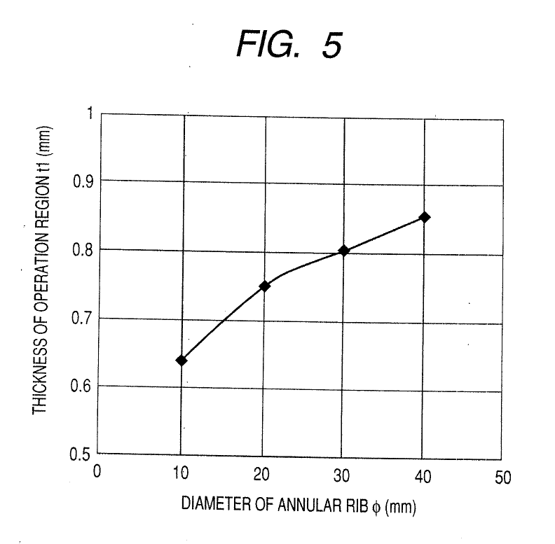

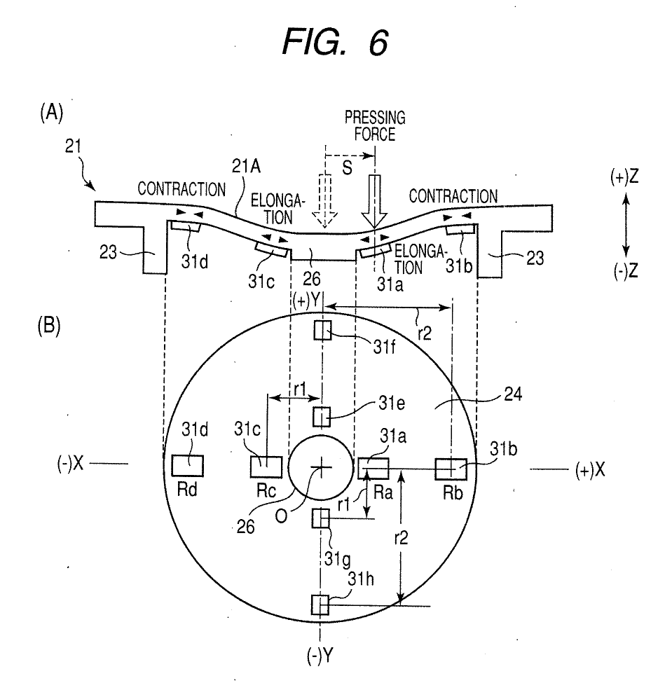

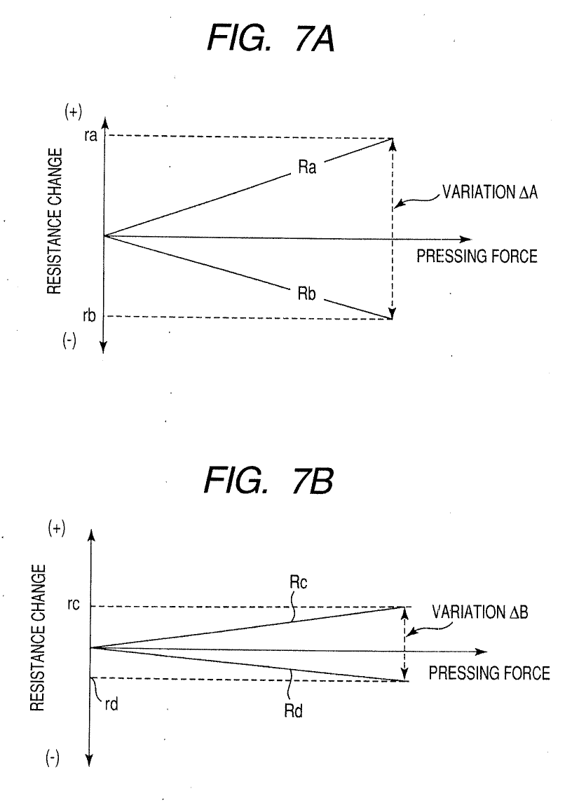

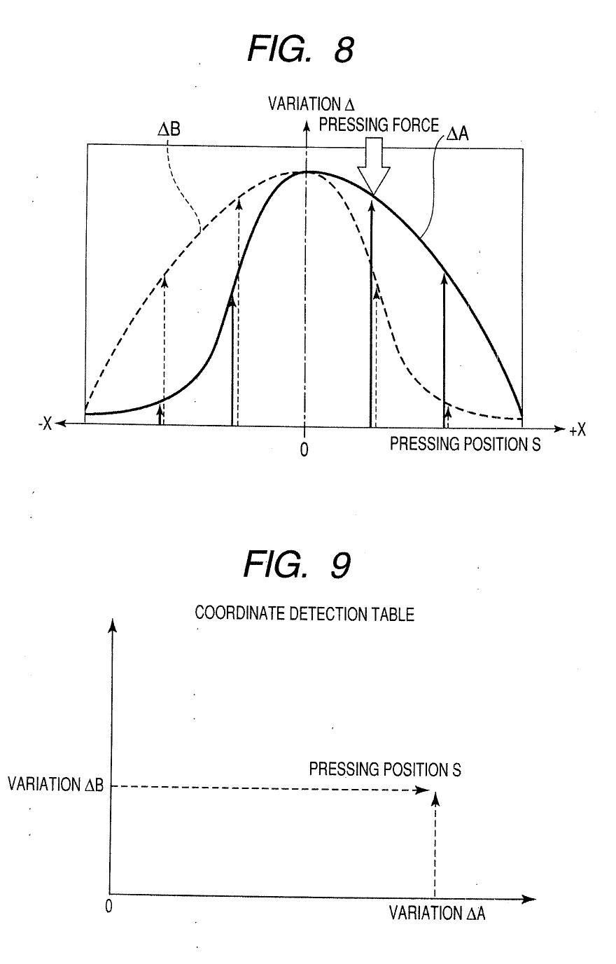

FIG. 1 is a plan view showing the appearance of a mobile phone that includes a pressing-type input device according to an embodiment of the invention. FIG. 2 is a perspective view showing the back surface of the pressing-type input device according to the embodiment of the invention. FIG. 3 is a cross-sectional view of FIG. 2. FIG. 4 shows another embodiment of an operation part, FIG. 4A is a perspective view showing the back surface of the operation part that includes an annular rib having double structure, and FIG. 4B is a perspective view showing the back surface of the operation part that includes reinforcing ribs. FIG. 5 is a graph showing a relationship between the diameter of the annular rib and the thickness of an operation region. FIG. 6 shows the disposition of pressure sensors of the pressing-type input device, FIG. 6A is a cross-sectional view of the pressing-type input device when the pressing-type input device is deformed, and FIG. 6B is a plan view schematically showing the back surface of the pressing-type input device. FIG. 7 is a graph showing an example of a relationship between a pressing force and the resistance change of a pressure sensor at an arbitrary pressing position S, FIG. 7A is a view showing a case where the pressing position is positioned on a positive side on an X axis, and FIG. 7B is a view showing a case where the pressing position is positioned on a negative side on an X axis. FIG. 8 is a graph showing a relationship between a pressing position and a variation. FIG. 9 is a conceptual diagram illustrating a method of finding the coordinates of the pressing position by using a coordinate detection table.

As shown in FIG. 1, a mobile phone 1 includes a case 10 where a first case 11 and a second case 12 are connected to each other so as to rotate about a shaft 13.

A plurality of push-button type key tops 14 is arranged on the front side (negative side on a Z axis) of the first case 11, and a pressing-type input device 20 is provided on the rear side (positive side on a Z axis) thereof. Further, a display part 15 formed of a liquid crystal panel is provided in the second case 12.

When being folded so that a surface on which the key tops 14 are provided and the surface of the display part 15 face each other, the mobile phone 1 is in a non-use state. When being unfolded so that an angle between the first and second cases 11 and 12 becomes about 180° (a state shown in FIG. 1), the mobile phone is in a use state.

It is possible to input numerals or letters by pressing the key tops 14 in the use state. Further, the pressing-type input device 20 is used as a determination key as described below, or detects the pressing force and the pressing position.

FIG. 2 shows the pressing-type input device from the back surface (rear surface).

The pressing-type input device 20 includes an operation part 21 and a plurality of pressure sensors 31 (individually indicated by 31a, 31b, 31c, 31d, 31e, 31f, 31g, and 31h) provided in the operation part.

The operation part 21 is made of a resin such as an ABS resin so as to have a substantially square shape, and the surface of the operation part is an operation surface 21A on which an operating input is performed by a finger and the like. As shown in FIG. 2, side walls 22, 22, 22, and 22 having a predetermined height are formed at four sides of the operation part 21 on the back surface thereof, and an annular rib 23 having a predetermined diameter is formed inside the side walls 22, 22, 22, and 22.

As shown in FIG. 3, for example, the operation part 21 is provided in a hole 12A formed at the second case 12 while being locked to a locking means (not shown). A stepped portion 12a is formed on the inner surface of the hole 12A, and the operation part 21 is supported so that the lower surfaces of the side walls 22, 22, 22, and 22 come in contact with the stepped portion 12a. Meanwhile, in this state, the operation surface 21A is set substantially flush with the surface of the second case 12.

As shown in FIG. 3, an inner region partitioned by the annular rib 23 is an operation region 24 of the pressing-type input device 20. The thickness t1 of the operation region 24 is smaller than the thickness t2 of an outer region 25 that is formed outside the annular rib 23 (t1<t2). For this reason, the inner portion of the operation region 24 is locally more flexible than the annular rib 23 and the outer region 25 formed outside the annular rib 23.

That is, it is possible to definitely divide the flexible operation region 24 from the outer region 25 that has high rigidity with small deformation. Accordingly, even though the outer region having high rigidity is pressed by mistake, the pressure sensor may not detect this input operation.

In addition, for example, the operation region 24 and the outer region 25 may not be used at a bottom of the second case 12, and may be divided by the operation region 24 or the annular rib 23 that is provided only at the lower surface of the operation part 21. For this reason, the input device may be a thin pressing-type input device 20.

Meanwhile, if the operation region 24 and the outer region 25 are formed to have the same thickness, the thickness t1 may be formed to be substantially smaller than the thickness t2 by forming reinforcing plates (not shown) only on the outer region 25 that forms the outer portion of the operation region 24. In this case, if being provided around the operation region 24 on the reinforcing plates, a plurality of pins or screws may be used instead of the annular rib.

Further, as for a case where the thickness t1 of the operation surface 21A should be small, in order to suppress the deformation of the operation region 24, for example, the annular rib 23 may be formed to have double structure as shown in FIG. 4A, or reinforcing ribs 23A that radially extend from the outer surface of the annular rib 23 toward the outer region 25 may be integrally formed with the annular rib as shown in FIG. 4B. Furthermore, apertures 23a, which are the same as those shown in FIG. 2, may be formed at the annular rib 23.

As shown in FIG. 2, in this embodiment, circular arc apertures 23a, 23a, 23a, and 23a are formed at portions of the annular rib 23 that intersect the X and Y axes orthogonal to each other. Further, a convex portion 26 is integrally formed at the center of the annular rib 23, that is, at a position where the X and Y axes are orthogonal to each other at the center of the rear side of the operation region 24.

The plurality of apertures 23a formed at the annular rib 23 is formed to mainly adjust the rigidity of the operation part 21 and the deformation of the operation region 24 in a thickness direction. However, if appropriate deformation can be obtained by setting the diameter of the annular rib 23 and the thickness of the operation region 24 in a preferable range as described below, the plurality of apertures 23a may be formed or may not be formed at the annular rib 23.

Each of the pressure sensors 31 of this embodiment is a pressurization-resistance variation type sensor, and is formed of, for example, a thin sheet-shaped member having flexibility. If the pressure sensor 31 is deformed in an elongating direction, a resistance value is changed to be larger than an initial value. If the pressure sensor is deformed in a contraction direction, a resistance value is changed to be smaller than an initial value.

The pressure sensors 31 are fixed to the back surface of the operation part 21 by an adhesive or the like, or are formed by embedding resistive elements in the operation part 21 when the insert molding of the resin is performed. Alternatively, pressurization resistive elements are formed on the back surface of the operation part 21 by screen printing or the like.

As shown in FIG. 2, in this embodiment, all of the plurality of pressure sensors 31a, 31b, 31c, 31d, 31e, 31f, 31g, and 31h are provided in the operation region 24. More particularly, the pressure sensors 31a, 31b, 31c, and 31d, which form a first pressure detecting unit, are disposed on the X axis. The pressure sensors 31e, 31f, 31g, and 31h, which form a second pressure detecting unit, are disposed on the Y axis.

Further, the pressure sensors 31a, 31c, 31e, and 31g are disposed around the convex portion 26 that is provided at the center of the annular rib. The pressure sensors 31b, 31d, 31f, and 31h are disposed at the inner peripheral portion of the annular rib 23 and inside the plurality of the apertures 23a.

The pressure sensor (first sensor) 31a and the pressure sensor (third sensor) 31c, which are close to the center of the annular rib on the X axis, are provided at positions that are symmetric with respect to the intersection and are spaced apart from the intersection by a distance r1, respectively. The pressure sensor (second sensor) 31b and the pressure sensor (fourth sensor) 31d, which are close to the annular rib on the X axis, are provided at positions that are symmetric with respect to the intersection of the X and Y axes and are spaced apart from the intersection by a distance r2, respectively (r1>r2). Likewise, the pressure sensor (first sensor) 31e and the pressure sensor (third sensor) 31g, which are close to the center of the annular rib on the Y axis, are provided at positions that are symmetric with respect to the intersection and are spaced apart from the intersection by a distance r1, respectively. The pressure sensor (second sensor) 31f and the pressure sensor (fourth sensor) 31h, which are close to the annular rib on the Y axis, are provided at positions that are symmetric with respect to the intersection and are spaced apart from the intersection by a distance r2, respectively (r1>r2) (see FIG. 6).

If the plurality of apertures 23a is formed at the annular rib 23, the wiring between the pressure sensors 31a, 31b, 31c, 31d, 31e, 31f, 31g, and 31h and an external circuit (not shown) extend into the operation region 24 through the apertures. Meanwhile, if the pressure sensors 31 are insert-molded in the resin, the wiring may be formed in the resin.

A relationship between the diameter (inner diameter) of the annular rib 23 and the thickness of the operation region 24 will be described herein.

First, it is assumed that a standard load applied to the operation part 21 is 5N (490 gf). Further, when the operation surface 21A, which has the diameter (inner diameter) φ of the annular rib about 23 of about 20 mm and the thickness t1 of about 0.75 mm, is pressed by the standard load, the deformation is referred to a reference value ε0. When the diameter (inner diameter) φ of the annular rib 23 is variable while the standard load is applied to the operation surface 21A, the deformation of the operation surface 21A occurs. When the deformation of the operation surface becomes the reference value ε0, the thickness t1 of the operation part 21 is obtained and is referred to as a plot.

The diameter φ of the annular rib 23 is larger than a standard size of a human finger by about 10 to about 40 mm. From FIG. 5, it is found out that the thickness t1 of the operation part 21 where the deformation corresponding to the reference value ε0 can be obtained is in the range of about 0.64 to about 0.85 mm in this case.

If the thickness t1 is in the range less than about 0.64 mm, the deformation is excessively increased. Accordingly, the pressure sensors 31 are saturated and do not operate. If the thickness t1 becomes excessively larger than about 0.85 mm, the operation part 21 is excessively hardened. Accordingly, it is not possible to obtain desired displacement, and the sensitivity of each of the pressure sensors 31 deteriorates. Therefore, it is preferable that the thickness t1 of the operation part 21 be in the range of about 0.64 to about 0.85 mm.

Meanwhile, the above-mentioned relationship has been described about the case where the apertures 23a are not formed at the annular rib 23, but may be applied to a case where the apertures 23a are formed at the annular rib.

The operation of the pressing-type input device 20 according to the above-mentioned embodiment will be described.

Meanwhile, the pressure sensors 31a and 31b and the pressure sensors 31c and 31d, which are provided on the X axis, will be used in the following description. However, the pressure sensors 31e and 31f and the pressure sensors 31g and 31h, which are provided on the Y axis, are the same as described using the pressure sensors provided on the Y axis.

If the central portion of the operation part 21 of the pressing-type input device 20 is pressed as shown by a dotted line in FIG. 6, the convex portion 26 positioned at the center of the operation region 24 is pushed to the lowest position in the drawing, so that the deformation is gradually decreased toward the outer peripheral portion where the annular rib 23 is formed. In this case, an elongating force is applied to each of the pressure sensor (first sensor) 31a and the pressure sensor (third sensor) 31c, which are close to the center of the annular rib, in the X axis direction. A contraction force is applied to each of the pressure sensor (second sensor) 31b and the pressure sensor (fourth sensor) 31d, which are close to the annular rib, in the X axis direction.

For this reason, assuming that the resistance value of the pressure sensor 31a is represented by Ra and the resistance value of the pressure sensor 31b is represented by Rb, the resistance value Ra of the pressure sensor 31a is changed so as to increase, and the resistance value Rb of the pressure sensor 31b is changed so as to decrease.

Likewise, assuming that the resistance value of the pressure sensor 31c is represented by Rc and the resistance value of the pressure sensor 31d is represented by Rd, the resistance value Rc of the pressure sensor 31c is changed so as to increase, and the resistance value Rd of the pressure sensor 31d is changed so as to decrease.

In this case, as shown in FIG. 6, assuming that the variations of the resistance values Ra and Rb of the pressure sensors 31a and 31b positioned on the X axis so as to be closer to the positive side than the central point are represented by ra and rb and the entire variation (the variation corresponding to the positive side on the X axis) of the pressure sensors 31a and 31b is represented by a first variation ΔA, ΔA=|ra|+|rb| is satisfied. Likewise, assuming that the variations of the resistance values Rc and Rd of the pressure sensors 31c and 31d positioned on the X axis so as to be closer to the negative side than the central point are represented by rc and rd and the entire variation (on the negative side on the X axis) of the pressure sensors 31c and 31d is represented by a second variation ΔB, ΔB=|rc|+|rd| is satisfied.

For example, if the upper portion (referred to as a pressing position S) of the pressure sensor 31a, which is positioned on the X axis so as to be closer to the positive side than the center, is pressed as shown by a solid line in FIG. 6, the pressure sensors 31a and 31c close to the center of the annular rib elongate but the pressure sensors 31b and 31d close to the annular rib contract. In this case, the elongation of the pressure sensor 31a close to the pressing position S is larger than that of the pressure sensor 31c distant from the pressing position, and the contraction of the pressure sensor 31b close to the pressing position S is smaller than that of the pressure sensor 31d distant from the pressing position.

For this reason, when the upper portion of the pressure sensor 31a is set to the pressing position S as shown in FIGS. 7A and 7B, a magnitude correlation between the variations ra, rb, rc, and rd of the resistance values Ra, Rb, Rc, and Rd of the pressure sensors 31a, 31b, 31c, and 31d is represented using absolute values as follows: |ra|>|rb|>|rc|>|rd|. In this case, a magnitude correlation between the first and second variations ΔA and ΔB is represented by ΔA>ΔB.

When a horizontal axis represents the position of the pressing position S on the X axis and a vertical axis represents variations (first and second variation ΔA and ΔB) as shown in FIG. 8, the first variation ΔA of the pressure sensors 31a and 31b can be shown by a solid line according to the pressing position S and the second variation ΔB of the pressure sensors 31c and 31d can be shown by a dotted line according to the pressing position.

For this reason, a coordinate detection table shown in FIG. 9 is set, one of the first variation ΔA that corresponds to the positive side on the X axis and the second variation ΔB that corresponds to the negative side on the X axis is represented on a vertical axis of the coordinate detection table, and the other thereof is represented on a horizontal axis of the coordinate detection table, so that it is possible to obtain a coordinate of the pressing position S on the X axis.

Likewise, one of the third variation ΔC that corresponds to the positive side on the Y axis and the fourth variation ΔD that corresponds to the negative side on the Y axis is represented on a vertical axis of the coordinate detection table and the other thereof is represented on a horizontal axis of the coordinate detection table by using the pressure sensors 31e, 31f, 31h, and 31g that are provided on the Y axis, so that it is possible to obtain a coordinate of the pressing position S on the Y axis.

If the pressing position S exists on the X or Y axis on which the pressure sensors 31 are positioned, it is possible to obtain the pressing position S by the above-mentioned method.

However, if the pressing position S does not exist on the X or Y axis, that is, if the pressing position exists at an arbitrary position on the surface of the operation part 21 (at a position except for positions on the X or Y axis), it is not possible to detect the pressing position by the above-mentioned method.

In this case, it is possible to obtain the coordinates from a ratio (first ratio) ΔA/ΔB of the first variation ΔA that corresponds to the positive side on the X axis and the second variation ΔB that corresponds to the negative side on the X axis, and a ratio (second ratio) ΔC/ΔD of the third variation ΔC that corresponds to the positive side on the Y axis and the fourth variation ΔD that corresponds to the negative side on the Y axis. That is, the first ratio ΔA/ΔB is represented on one of the vertical and horizontal axes of the coordinate detection table and the second ratio ΔC/ΔD is represented on the other thereof, so that it is possible to accurately obtain the pressing position S on the operation surface 21A.

The pressing position S, which can be detected in the above description, is not limited to the operation region 24, and it is possible to detect the pressing position S in the entire operation surface 21A that includes the operation region 24 and the outer region 25 thereof.

The pressing-type pressing position is used in the pressing-type input device 20 according to the embodiment of the invention as described above, so that it is possible to detect the coordinates of the pressing position S.

Meanwhile, the pressing-type input device according to the embodiment of the invention may be used as a determination key, but pressing may be detected on the basis of the detection of whether the outputs of the plurality of pressure sensors 31 exceed a predetermined value at the same time. Further, a pressing-type switch is separately provided below the operation part 21, and pressing may be detected on the basis of whether the switch is pushed by the convex portion 26.

Furthermore, it is possible to accurately obtain a pressing force from the conversion of the first variation ΔA that corresponds to the positive side on the X axis, the second variation ΔB that corresponds to the negative side on the X axis, the third variation ΔC that corresponds to the positive side on the Y axis, and the fourth variation ΔD that corresponds to the negative side on the Y axis. For example, it is possible to accurately obtain a pressing force from a correspondence relationship between the sum ΔA+ΔB+ΔC+ΔD of the first to fourth variations and a predetermined conversion table or a relationship.

A press resistance change type sensor has been used as the pressure sensor 31 in the above-mentioned embodiment. However, as long as a sensor of which physical quantity is changed according to a pressing force is used in the invention, the invention is not limited thereto. For example, a capacitance type sensor of which capacitance is changed according to a pressing force may be used.

Further, the operation part 21 of the input device 20 has been formed of a body that is separated from the second case 12 of the mobile phone. However, the invention is not limited thereto, and the operation part 21 may be integrally formed with the second case 12. That is, the operation region 24 may be formed at a part of the second case 12.

It should be understood by those skilled in the art that various modifications, combinations, sub-combinations and alterations may occur depending on design requirements and other factors insofar as they are within the scope of the appended claims of the equivalents thereof.

What is claimed is:

1. A pressing-type input device comprising:
an operation part; and
pressure sensors that are provided on the lower surface of the operation part,
wherein the operation part includes an operation region where the pressure sensors are provided, and an outer region that is formed outside the operation region, and
an inner portion of the operation region is locally more flexible than the outer region that is formed outside the operation region.

2. The pressing-type input device according to claim 1,
wherein the thickness of the operation region is smaller than that of the outer region.

3. The pressing-type input device according to claim 1,
wherein a rib is integrally formed on the lower surface of the operation part, and
the operation region and the outer region are partitioned by the rib.

4. The pressing-type input device according to claim 3,
wherein the rib is an annular rib that is formed continuously or intermittently.

5. The pressing-type input device according to claim 1,
wherein reinforcing plates are provided on the lower surface of the outer region except for the inner portion of the operation region.

6. The pressing-type input device according to claim 1,
wherein the operation part is made of an ABS resin,
the diameter of the operation region is in the range of about 10 to 4 about 0 mm, and
the thickness of the operation region is in the range of about 0.64 to about 0.85 mm.

7. A pressing-type input device comprising:
an operation part that includes an operation region; and
a plurality of pressure sensors that are provided in the operation region, the physical quantity of each of the pressure sensors being changed according to deformation,
wherein the pressure sensors includes at least first and third sensors that are positioned so as to be symmetric with respect to the center of the operation region and spaced apart from the center by the same distance r1 (>0), respectively, and the second and fourth sensors that are positioned so as to be symmetric with respect to the center and spaced apart from the center by the same distance r2 (>r1), respectively, and
the first to fourth sensors are disposed on the same straight line.

8. The pressing-type input device according to claim 7,
wherein assuming that the sum of physical variations of the first and second sensors generated when an arbitrary position on the straight line is pressed is represented on a horizontal axis as a first variation and the sum of physical variations of the third and fourth sensors is represented on a vertical axis as a second variation, an intersection of the first and second variations is detected as a pressing position on the straight line.

9. The pressing-type input device according to claim 7,
wherein the first to fourth sensors are provided as a first pressure detecting unit on one axis of X and Y axes that are orthogonal to each other, and
another first to fourth sensors are provided as a second pressure detecting unit on the other axis thereof.

10. The pressing-type input device according to claim 9,
wherein when an arbitrary position in the operation region is pressed, a ratio of the first and second physical variations detected on the X axis is set as a first ratio on a horizontal axis, a ratio of the third and fourth physical variations detected on the Y axis is set as a second ratio on a vertical axis, and an intersection of the first and second variations is detected as a pressing position.
